(19) United States
(12) Patent Application Publication
(10) Pub. No.: US 2007/0071251 A1
(43) Pub. Date: Mar. 29, 2007

(54) Audio switch

(76) Inventor: Ian MacDuff, Los Angeles, CA (US)

Correspondence Address: EDWIN TARVER, 16830 Ventura Blvd., SUITE 360, Encino, CA, 91436, US

(21) Appl. No.: 11/233,248

(22) Filed: Sep. 21, 2005

(51) Int. Cl. H04B 3/00

(52) U.S. Cl. 381/81

(57) ABSTRACT

An automatic audio switching system comprising first and second audio devices connected to the switching circuit and to the output speaker, said circuit comprising of a relay, switching device, diodes, a capacitor, resistor and a transformer. Said transformer boosts up received ac voltage, then the diode rectifies the ac to dc, the capacitor and resister make a 2 second timer, the transistor switch, switches to ground changing the pole of said relay thus changing output of the system from one audio system to other.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF INVENTION

This invention generally relates to a switching device, more specifically to an audio switching device, still more precisely to a hands free automatic audio switching device capable of switching output from any music player and GPS system as PDA.

### BACKGROUND OF THE INVENTION

There are various switching devices available for audio switching to be used specifically in vehicles. U.S. Pat. No. 6,134,456 discusses integrated mobile-phone hands free kit combined with an existing vehicular stereo system utilizes the high power and high performance audio output. The stereo equipment has a sound output wire and an electric power supply input wire. The electric power module has a hands free kit electric circuit assembly. The hands free kit electric circuit assembly has a sound source selecting switch unit, a power amplifier, an earphone circuit, an audio fidelity processing unit, an electric power supply unit, a sound source control unit, and an electric power supply switch. The invention makes it possible to integrate the mobile-phone hands free kit together with a vehicular stereo system to automatically detect the sound source (from stereo or mobile-phone) and then direct the audio signal to the loudspeaker output, and therefore simplifies wiring and eliminates the needs for extra power source and loudspeakers. The integrated hands free kit also controls the loudspeakers in different locations by applying various output powers and phase delays for each loudspeaker in order to process the audio signal and simulate the sound fields as if the sound were coming from the front to allow drivers to concentrate on traffic while in conversation via mobile-phone. This system is complex, costly as requires a power amplifier unit, and audio fidelity processing unit and very limited in its use in vehicles only.

In another U.S. Pat. No. 5,243,640, a system is discussed which is again limited in its use and is used in vehicles only in which output transducer and amplifier are shared between an audio system and a cellular Phone in an automotive vehicle. An interface arbitrates between the program audio signals and the phone audio signals to select or deselect each of the audio signals depending on the status of each audio source. When only one source is in use then normally the audio signals from that source are selected. If both sources are turned on but a phone call is not in progress, then audio signals from both sources are simultaneously presented to the output transducers after summing. When a call is in progress, only the phone audio signals are selected. This system requires many components as summer, buffers and control circuit and thus is not only complex abut costly and limited in its use in vehicles only.

U.S. patent application, publication No. 2003/0,104,834 discusses a mobile phone call receiving device capable of automatically turning off car stereo for a user to safely use the mobile phone when driving. The device includes: a main frame for sensing a radio-frequency signal input by the mobile phone and sending out a carrier signal and an extension which according to the carrier signal turns off the car stereo or silences the car stereo. When receiving a mobile phone call, the device is able to turn off the car stereo or silence the car stereo so that a user can concentrate on using the mobile phone without the distraction of silencing the car stereo. Here a processor for sensing mobile signals is used making it a costly and a complex device with a limited application in vehicles only.

The switching function performed by this invention is simplest, cheapest and can be used with any type of audio device available in the market even computers and is not limited to be used in the vehicles.

### OBJECT OF THE INVENTION

Therefore the object of the present invention is to provide an audio switching device.

It is further object of the present invention to provide with an automatic audio switching device.

Another object of the present invention is to provide with a simple, small and low-cost device.

Yet another object of the present invention is to provide with a device which can be used with any audio device.

Still another object of the present invention to provide with a device that can be used anywhere and is not limited in its application in vehicles only.

### SUMMARY OF THE INVENTION

The automatic audio switching system comprises a first audio system, a second audio system, a switching circuit having two input lines receiving inputs from the first and second audio system and an output line for providing output, and a plurality of speakers connected to the output lines of said switching circuit. Wherein the switching circuit comprises a first diode, a transformer, receiving input at its primary winding and secondary winding is connected to first end of said first diode, a second diode, a relay connected to said plurality of speakers and a plurality of audio systems for enabling one audio output, said second diode is connected in parallel to the winding of relay and one end of said second diode is connected to the power supply, a capacitor, a resistor connected in parallel to said capacitor, a switching device having first and second conducting end and a controlling end, one end of said parallel connection of resistor and capacitor and second end of said first diode are connected together to controlling end of switch and one conducting end is connected to said relay for switching the circuit from one audio system to other. Said transformer boosts up received ac voltage, then the diode rectifies the ac to dc, the capacitor and resister make a 2 second timer, the transistor switch, switches to ground changing the pole of said relay thus changing output of the system from one audio system to other.

### BRIEF DESCRIPTION OF THE DRAWINGS

FIG. 1 shows a basic block diagram of the presented work.

FIG. 2 shows circuit diagram of presented device.

### REFERENCE NUMERALS

1 . . . Relay
2 . . . Input power
3, 11 . . . Diode
5 . . . Transistor
7 . . . Capacitor
9 . . . Resistor
10 . . . Ground
13 . . . Transformer
15 . . . iPOD
17 . . . PDA
20 . . . 1^{st} audio system
30 . . . 2^{nd} audio system
40 . . . Switching device
50 . . . Speaker

### DETAILED DESCRIPTION OF THE DRAWINGS

A further understanding of the present invention may be obtained with reference to the following description taken in conjunction with the accompanying drawings. However, the embodiments used for describing the invention are illustrative only and no way limiting scope of the invention. A person skilled in the art will appreciate that many more embodiments of the invention are possible without deviating from the basic concept of the invention any such embodiment will fall under the scope of the invention and is a subject matter of protection.

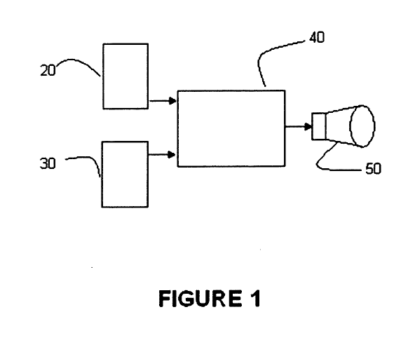

FIG. 1 shows a basic block diagram of the presented work; here 20 and 30 are the two audio system providing audio output and block 40 represent audio switch. When only one system is working switch selects output from that as the audio output at the speaker 50, when both the system 20, 30 are working the switch makes selection according to the requirement, as if the second device is PDA or mobile output from that will be given a priority and selected as the output to the speaker 50.

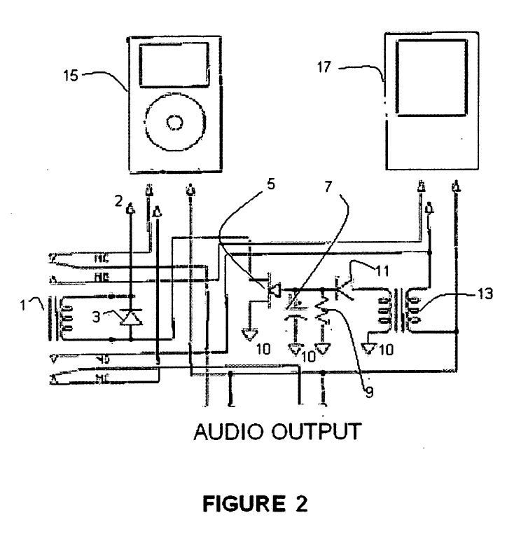

FIG. 2 shows the circuit diagram of the presented work. The transformer 13, receives ac voltage from the PDA 17 and boosts it up, then the diode 11 rectifies the ac to dc. Capacitor 7 and resister 9 make a 2 second timer that turns the transistor 5 on or off according to the requirements this transistor switch is a switch to ground 10. Input power 2 is applied to the relay 1 that is used to make selection of audio output depending upon the status of the transistor switch 5.

What is claimed is:

1. An audio switching system comprising:
a first audio system;
a second audio system;
a switching circuit having two input lines receiving inputs from the first and second audio system and an output line for providing output, and;
a plurality of speakers connected to the output lines of said switching circuit.

2. An audio switch system as defined in claim 1, wherein switching circuit further comprises:
a first diode;
a transformer, receiving input at its primary winding and secondary winding is connected to first end of said first diode;
a second diode;
a relay connected to said plurality of speakers and a plurality of audio systems for enabling one audio output, said second diode is connected in parallel to the winding of relay and one end of said second diode is connected to the power supply;
a capacitor;
a resistor connected in parallel to said capacitor;
a switching device having first and second conducting end and a controlling end, one end of said parallel connection of resistor and capacitor and second end of said first diode are connected together to controlling end of switch and one conducting end is connected to said relay for switching the circuit from one audio system to other.

3. An audio switching circuit as defined in claim 2, wherein said relay is a double pole double throw relay.

4. An audio switching system as defined wherein in one embodiment the audio systems may be iPOD and PDA.

5. An audio switching system as defined in claim 2, wherein said parallel combination of capacitor and resistor provides a timer of 2 seconds to said switching circuit.

6. A method for automatic audio switching circuit, comprising the steps of:
providing with a first and a second audio system;
providing with a plurality of speakers;
providing with a transformer;
providing with a plurality of diodes;
providing with a switching device;
providing with a relay;
providing with a capacitor;
providing with a resistor;
boosting up the input ac voltage received at the primary winding of the transformer;
rectifying the ac output received at the secondary winding of said transformer using said diode;
providing with a timer of 2 seconds to said switching device using the parallel combination of the capacitor and resistor;
switching said switching device depending upon the inputs from the audio systems, and;
changing the pole of said relay to switch output from one audio switch to another audio switch.
